(19) United States
(12) Patent Application Publication
(10) Pub. No.: US 2020/0006932 A1
(43) Pub. Date: Jan. 2, 2020

(54) Smart Split Washer Cable Gland Entry

(71) Applicant: Appleton GRP LLC, Rosemont, IL (US)

(72) Inventors: Jean-Francois MONTEIL, SIGNY l'ABBAYE (FR); Vilian RUS, ZI Nord (FR); Eric DUMONT, ZI Nord (FR); Gregory KLEMESIAK, ZI Nord (FR); Bruno BOUVET, ZI Nord (FR)

(21) Appl. No.: 16/201,627

(22) Filed: Nov. 27, 2018

(30) Foreign Application Priority Data
Jul. 2, 2018 (FR) 18 56098

(51) Int. Cl. H02G 15/013; H02G 3/22; H02G 1/00; F16B 43/00

(52) U.S. Cl. CPC H02G 15/013; H02G 3/22; H02G 15/007; F16B 43/001; F16B 43/007; H02G 1/00

(57) ABSTRACT

A two-part washer for use with a cable gland is provided including a first partial annular part having a first end and a second end, and a second partial annular part having a first end and a second end, wherein the first end of the first part is adapted to interlock with the second end of the second part, wherein the second end of the first part is adapted to interlock with the first end of the second part, and wherein when the ends of the first and second parts are interlocked, an annular washer extending 360 degrees with an open interior is formed. A method of using the two-part washer to provide a watertight seal between a cable gland and a wall of an electrical enclosure is also provided.

### RELATED APPLICATION

This application claims priority to French Patent Application No. FR 18 56098 entitled “Smart Split Washer Cable Gland Entry” filed on Jul. 2, 2018, the contents of which is incorporated by reference herein in its entirety.

### FIELD

The present disclosure relates to washers used in conjunction with a cable gland through which an electrical cable passes and enters into an electrical enclosure. The cable gland provides strain-relief to the electrical cable and may be used for sealing cables passing through a wall of the electrical enclosure. More particularly, the present disclosure relates to washers that provide a water-tight seal between the cable gland and the wall of the electrical enclosure.

### BACKGROUND

Electrical enclosures are typically installed in industrial facilities that supply power to manufacturing or industrial equipment within the facility. In some cases, the electrical enclosures often include multiple cable entries that are located in the wall of the enclosure. Electrical cable is passed through the cable entries in the wall of the enclosure, and a cable gland is positioned around the electrical cable and the cable gland is secured to the cable entry of the wall of the electrical enclosure to allow the electrical cable to pass through the cable entry to the inside of the electrical enclosure for further electrical connection. A washer is typically positioned between the cable gland and the wall of the electrical enclosure.

In some applications, there may be over a hundred cable entries in a single wall of the electrical enclosure. In the event that a washer is forgotten during installation of the electrical cables and cable glands, or a washer is damaged via chemical or mechanical damage, a technician needs to disconnect the electrical cable from within the electrical enclosure, unscrew the cable gland, pull the electrical cable back out of the cable entry, place the washer around the electrical cable, reinsert the electrical cable back through the cable entry into the electrical enclosure, reconnect the electrical cable within the electrical enclosure, and tighten the cable gland into the cable entry with the washer positioned between the cable gland and the wall of the electrical enclosure.

This effort to add a forgotten washer, or replace a damaged washer, is time-consuming. However, in the cases where there are many, perhaps over a hundred, cable entries in a single wall of the electrical enclosure, the cable entries are located very close together, and to get to the cable gland that needs a washer may require that dozens or more of the cable glands and electrical cables need to be removed to get to the cable gland that needs to have a washer added or replaced. Therefore, it may be extremely time-consuming to replace or add a single washer because so many other cable glands and electrical cables may need to be removed.

Furthermore, the process of removing the electrical cable from the cable entry may damage the insulation on the electrical cable because of sharp edges that may be on the cable entry, causing even further efforts to replace the damaged electrical cable. In addition, when the electrical enclosure includes instrumentation cable screens, it may not be possible to disconnect the cable screens and have them be functional after disconnection and reconnection. Moreover, once all of the electrical cables and cable glands have been reinstalled, the wiring must be checked, by e.g. an IPOT, a continuity test, and an insulation test. In addition, a global functional test must also be done by engineers equipped with suitable calibrated testing equipment and or by trained, qualified engineers, resulting in high cost and delay. At the same time, during the time period in which the electrical cables and cable glands are disconnected and, removed, and then reconnected and reinstalled, the equipment to which the electrical enclosure serves to power suffers undesirable downtime, resulting in further consequential costs.

In addition, when the electrical enclosure is located in a hazardous environment, there must be a water tight seal between the cable gland and the wall of the enclosure to prevent water, liquid, or even chemicals from entering the electrical enclosure and causing a hazardous situation and potential malfunction of the electrical equipment within the electrical enclosure.

Therefore, it would be desirable to provide an alternative to the standard washer that can be added or replaced without having to undertake the costly and time-consuming process of removing a large number of cable glands and electrical cables and later reinstalling the cable glands and electrical cables. In addition, it would also be desirable to provide an alternative to the standard washer that provides a watertight seal between the cable gland and the wall of the enclosure, which is desirable in hazardous locations.

### SUMMARY

The present application advantageously provides embodiments of a washer that allow for the placement of the washer between the wall of an electrical enclosure and a cable gland, without requiring disconnecting the electrical cables and electrical wiring therein, or disconnecting cable screens. In one embodiment, the washer is a two-piece washer having a first part and a second part. To add or replace a washer between the wall of the electrical enclosure and the cable gland, the cable gland is unscrewed from the cable entry and then the first part of the washer is placed over the electrical cable between the cable gland and the wall of the electrical enclosure. Next, the second part of the washer is placed over the electrical cable and the ends of the first part and the second part of the washer are fitted together in a locking relationship to form a washer that completely surrounds the electrical cable. Once the two parts are fitted together in a locking relationship, the cable gland is screwed into the cable entry and the two-part washer squeezed between the cable gland and the wall of the enclosure to provide a watertight seal therebetween.

The use of a two-part washer eliminates the need to disconnect the electrical cable and wiring therein from within the electrical enclosure, and the need to pull the electrical cable back through the cable entry to install a washer. As a result, the time-consuming process of disconnecting and removing the electrical cable, and then reinstalling and reconnecting the electrical cable, is eliminated. Furthermore, the risk of damage to the insulation on the electrical and to cable screens is eliminated because the electrical cable is not removed and reinstalled through the cable entry. Furthermore, because the electrical cable remains connected and in respect of dedicated safety procedure like “fire permit” or “use of gas detector,” it may be possible to continue running the machinery or equipment that is powered by the electrical enclosure while the two-part washer is being installed, and testing to ensure the connections are proper is not required. Moreover, the process of adding or replacing a washer is made not only faster, but safer, because the risk of mistake or damage when reconnecting the electrical cables within the electrical enclosure is eliminated, as the electrical cables do not have to be disconnected during the addition or replacement of a washer.

In one embodiment, the two parts of the washer are identical, such that only a single part needs to be made for the two-part washer, instead of two disparate parts. This results in significant cost savings because only a single mold or tool is required to make the parts for the washer, and there is only a single part to inventory.

In another embodiment, a split washer and seal is advantageously provided. The ends of the split washer can be spread apart and the electrical cable is squeezed between the two ends of the washer such that the split washer surrounds the electrical cable. A seal is then placed between the ends of the split washer. A special tool may be used to hold the ends of the split washer tightly against the seal as the cable gland is screwed into the cable entry until the split washer provides a watertight seal between the cable gland and the wall of the electrical enclosure.

In one aspect, a two-part washer for use with a cable gland is provided including a first partial annular part having a first end and a second end, and a second partial annular part having a first end and a second end, wherein the first end of the first part is adapted to interlock with the second end of the second part, wherein the second end of the first part is adapted to interlock with the first end of the second part, and wherein when the ends of the first and second parts are interlocked, an annular washer extending 360 degrees with an open interior is formed.

In another aspect, a washer is provided including an annular ring having an open interior, the annular ring having a break therein forming a first end of the ring and a second end of the ring, and a seal positioned between the first end of the ring and the second end of the ring.

In a further aspect, a method is provided of providing a watertight seal between an end of a cable gland and a wall of an electrical enclosure, wherein an electrical cable extends through a cable entry in the wall into an interior of the electrical enclosure; including the steps of (i) providing a two-part washer for use with a cable gland including: a partial annular part having a first end and a second end, and a second partial annular having a first end and a second end, wherein the first end of the first part is adapted to interlock with the second end of the second part, wherein the second end of the first part is adapted to interlock with the first end of the second part, and wherein when the ends of the first and second parts are interlocked, an annular washer extending 360 degrees with an open interior is formed; (ii) placing the first part around the electrical cable at a position between the cable gland and the wall of the enclosure; (iii) placing the second part around an opposite side of the electrical cable than the first part; (iv) interlocking the first end of the first part with the second end of the second part and interlocking the second end of the first part with the first end of the second part to form the annular washer extending 360 degrees with the electrical cable extending through the open interior; (v) and tightening the cable gland into the cable entry with the washer positioned between the cable gland and the wall of the electrical enclosure to form a watertight seal between the cable gland and the wall of the electrical enclosure.

In yet a further aspect, a method is provided of providing a watertight seal between an end of a cable gland and a wall of an electrical enclosure, wherein an electrical cable extends through a cable entry in the wall into an interior of the electrical enclosure; including the steps of: (i) providing a washer having an annular ring having an open interior, the annular ring having a break therein forming a first end of the ring and a second end of the ring, and a seal positioned between the first end of the ring and the second end of the ring; (ii) locating a portion of the electrical cable between cable gland and the wall of the enclosure; (iii) moving the first and second ends of the annular ring apart and inserting the portion of the electrical cable into the open interior of the annular ring; (iv) positioning the seal between the first end of the annular ring and the second end of the annular ring; (v) positioning the annular ring into a tool to compress the first end of the annular and the second end of the annular ring against the tool; (vi) tightening the cable gland into the cable entry with the washer positioned between the cable gland and the wall of the electrical enclosure to form a watertight seal between the cable gland and the wall of the electrical enclosure; and (vii) removing the tool.

### BRIEF DESCRIPTION OF THE FIGURES

FIG. 1 is a side view of a cable gland 120 threaded into cable entry 160 of wall 150 of an electrical enclosure with standard washer 100 positioned between cable gland 120 and wall 150, and electrical cable 140 extending through cable gland 120 and cable entry 160 of wall 150.

FIG. 2 is a perspective view of a plurality of electrical cables 140 and cable glands 120 threaded into wall 150 of an electrical enclosure.

FIG. 3A is a perspective view of two-part washers 200, 300, and 400, according to example embodiments.

FIG. 3B is a top view of two-part washers 200, 300, and 440 shown in FIG. 3A shown in an un-interlocked state.

FIG. 3C is a top view of two-part washer 600 shown in an un-interlocked state.

FIG. 4A is a perspective view of two-part washer 200 being assembled around cable gland 120 and electrical cable 140.

FIG. 4B is a perspective view of two-part washer 200 in an interlocked state around cable gland 120 and electrical cable 140.

FIG. 4C is a perspective view of two-part washer 300 in an interlocked state between cable gland 120 and wall 150 after the lobes of the first part 210 are positioned within the recesses of second part 250, to form a washer extending 360 degrees is formed having any open interior through which an electrical cable may pass through.

FIG. 5A is a top view of two-part washer 300.

FIG. 5B is a perspective view of two-part washer 300.

FIG. 6A is a top view of washer 500 having annular ring 540 and seal 530.

FIG. 6B is a perspective view of washer 500 positioned over cable gland 120.

FIG. 6C is a side view of washer 500 positioned over cable gland 120.

FIG. 6D is a perspective view of washer annular ring 540 of washer 500 being placed around electrical cable 140.

FIG. 6E is a perspective view of washer 500 positioned over cable gland 120.

FIG. 6F is a perspective view of washer 500 positioned within tool 550.

FIG. 6G is a perspective view of washer 500 positioned over cable gland 120 and within tool 550, prior to cable gland 120 being threaded into a cable entry of a wall of an electrical enclosure.

FIG. 6H is a perspective view of cable gland 120 threaded into wall 150 of an electrical enclosure with washer 500 providing a watertight seal between cable gland 120 and wall 150.

FIG. 6I is a perspective view of washer 500′ having annular ring 540 and seal 530, as well as interlocking extensions 575 and 585.

### DETAILED DESCRIPTION

FIG. 1 is a side view of a cable gland 120 threaded into cable entry 160 of wall 150 of an electrical enclosure with standard washer 100 positioned between cable gland 120 and wall 150, and electrical cable 140 extending through cable gland 120 and cable entry 160 of wall 150. Electrical cable 140 extends through wall 150 and has a cable portion 142 positioned within the electrical enclosure where it may be further connected to components within the electrical enclosure.

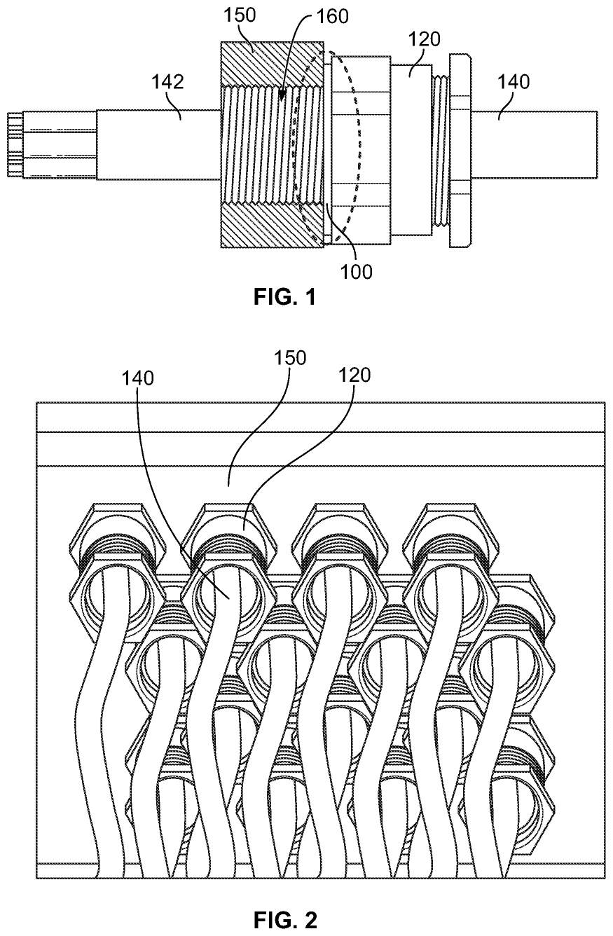

FIG. 2 is a perspective view of a plurality of electrical cables 140 and cable glands 120 threaded into wall 150 of an electrical enclosure. As can be seen in FIG. 2, there is a forest of cables 140 and cable glands 120 extending into wall 150 of an electrical enclosure. In this example there are sixteen hoses shown, but in other applications there may be over a 100 electrical cables and cable glands extending into a single wall of an electrical enclosure. As result, in the event that a washer needs to be added or replaced, it is very difficult and time-consuming, and perhaps damaging, to remove the electrical cables and cable glands to add or remove a washer.

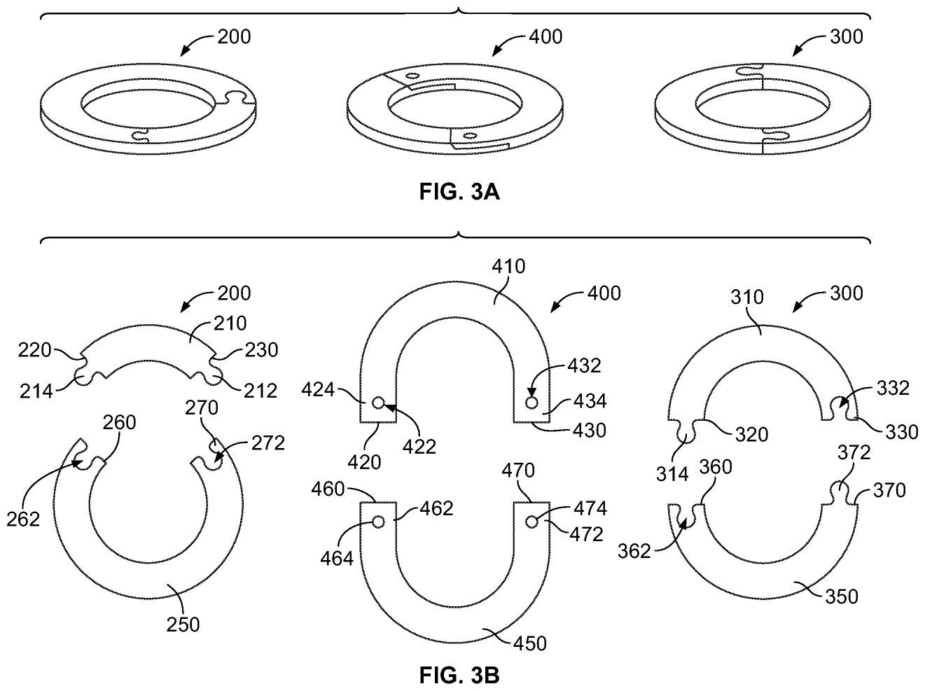

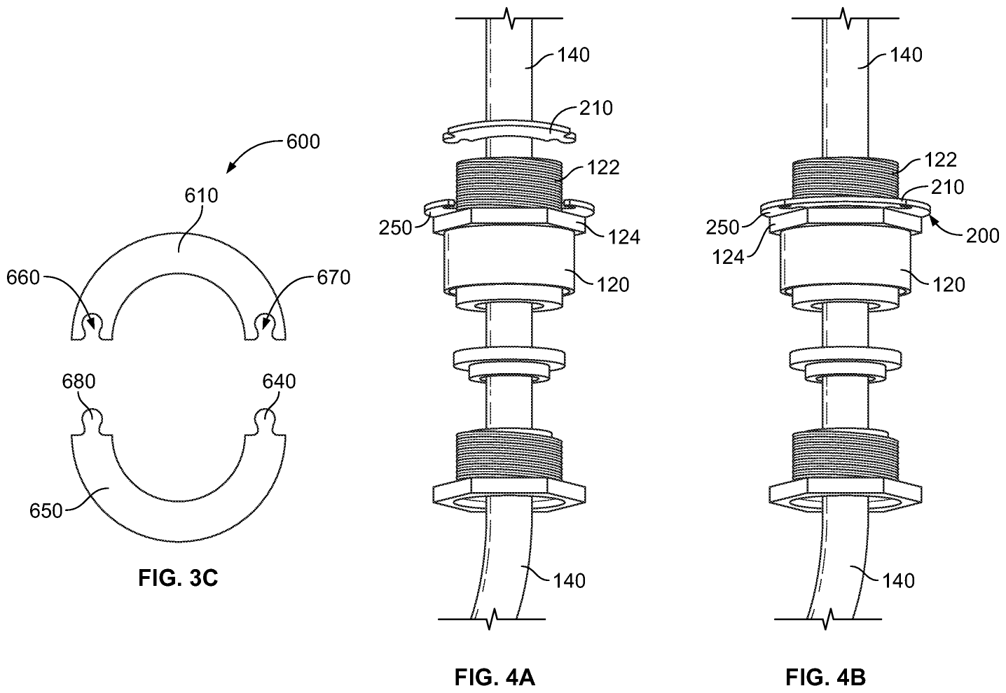

FIG. 3A is a perspective view of two-part washers 200, 300, and 400, according to example embodiments. FIG. 3B is a top view of two-part washers 200, 300, and 440 shown in FIG. 3A shown in an un-interlocked state. Two-part washer 200 includes a first part 210 having a first end 230 and a second end 220. Two-part washer 200 also includes a second part 250 having a first end 260 and a second end 270. First end 230 includes a lobe 212 extending therefrom which is adapted to be positioned within, and interlock with, recess 272 on second end 270 of second part 250. Similarly, second end 220 of first part 210 includes a lobe 214 which is adapted to be positioned within, and interlock with, recess 262 on first end 260 of second part 250. To position lobe 212 within recess 272, and to position lobe 214 within recess 262, first part 210 is moved axially into part 250, i.e. from above or below.

Lobe 212 fits within recess 272 like the lobe of a jigsaw puzzle piece, such that once in position the lobe 212 is interlocked with recess 272. Similarly, Lobe 214 fits within recess 262 like the lobe of a jigsaw puzzle piece, such that once in position the lobe 214 is interlocked with recess 262. Once the lobes of the first part 210 are positioned within the recesses of second part 250, an annular washer extending 360 degrees is formed having any open interior through which an electrical cable may pass through.

Two-part washer 300 includes a first part 310 having a first end 320 and a second end 330. Two-part washer 300 also includes a second part 350 having a first end 370 and a second end 360. First end 320 includes a lobe 314 extending therefrom which is adapted to be positioned within, and interlock with, recess 362 on second end 360 of second part 350. Similarly, first end 370 of second part 350 includes a lobe 372 which is adapted to be positioned within, and interlock with recess 332 on second end 330 of first part 310. To position lobe 314 within recess 362, and to position lobe 372 within recess 332, first part 310 is moved axially into part 350, i.e. from above or below, or vice versa.

Lobe 314 fits within recess 362 like the lobe of a jigsaw puzzle piece, such that once in position the lobe 314 is interlocked with recess 362. Similarly, Lobe 372 fits within recess 332 like the lobe of a jigsaw puzzle piece, such that once in position the lobe 372 is interlocked with recess 332. Once the lobe 314 of the first part 310 is positioned within the recess 362 of second part 350, and lobe 372 of second part 350 is positioned within recess 332 of first part 310, an annular washer extending 360 degrees is formed having any open interior through which an electrical cable may pass through.

In two-part washer 300, first part 310 and second part 350 are identical such that the same part may be used for both the first part and the second part. As a result, only a single mold or tool is required to create both the first part 310 and the second part 350, resulting in cost savings in terms of tooling and being required to inventory only a single part.

Two-part washer 400 includes a first part 410 having a first end 420 and a second end 430. Two-part washer 400 also includes a second part 450 having a first end 470 and a second end 460. First end 420 includes a flange 424 having an aperture 422 therein and second end 430 includes a flange 434 having an aperture 432 therein. Second end 460 of second part 450 includes a flange 462 having an upwardly extending protrusion 464 thereon, and first end 470 of second part 450 includes a flange 472 having an upwardly extending protrusion 474 thereon.

Upwardly extending protrusion 464 on second end 460 of second part 450 is adapted to be positioned within, and interlock with, aperture 422 on flange 424 on first end 420 of first part 410. Similarly, upwardly extending protrusion 474 on first end 470 of second part 450 is adapted to be positioned within, and interlock with, aperture 432 on flange 434 on second end 430 of first part 410. To position protrusion 464 within aperture 422, and to position protrusion 474 within aperture 432, first part 410 is moved over second part 450 and the apertures are axially moved downwardly until the protrusions are positioned within the apertures. Once the protrusions of the second part 450 are positioned within the apertures of first part 410, an annular washer extending 360 degrees is formed having an open interior through which an electrical cable may pass through.

FIG. 3C is a top view of two-part washer 600 shown in an un-interlocked state. FIG. 3C is similar to two-part washer 300 shown in FIGS. 3A-B, although in two-part washer 600, second part 650 includes two lobes 680 and 640 that fit within recesses 660 and 670 on first part 610. Lobe 680 interlocks with recess 660, and lobe 640 interlocks with recess 670 to form an annular washer extending 360 having an open interior through which an electrical cable may pass through.

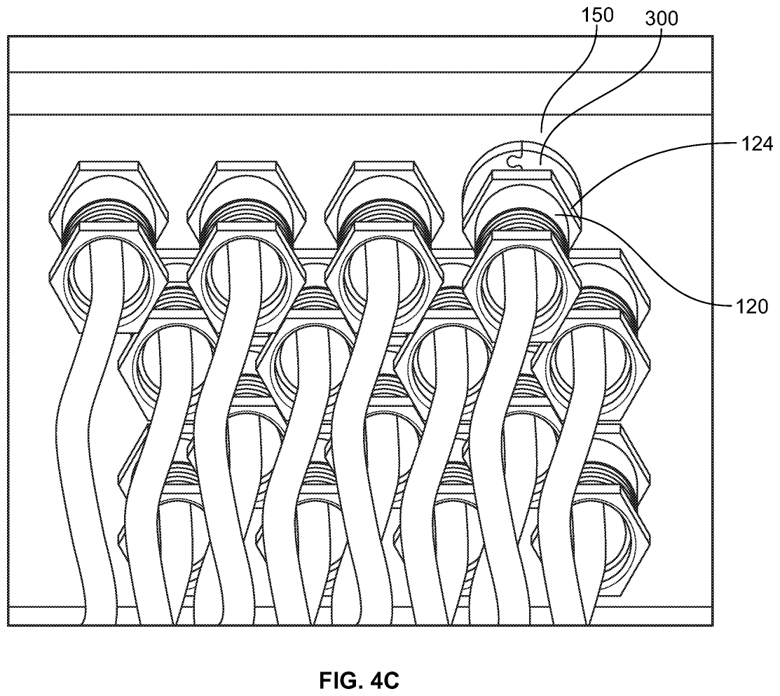

FIG. 4A is a perspective view of two-part washer 200 being assembled around cable gland 120 and electrical cable 140. FIG. 4B is a perspective view of two-part washer 200 in an interlocked state around cable gland 120 and electrical cable 140. At this point, the cable gland 120 is ready to be screwed into a cable entry on the wall of an electrical enclosure, and the washer 200 will form a watertight seal between the cable gland 120 and the wall of the electrical enclosure.

FIG. 4C is a perspective view of two-part washer 300 in an interlocked state between cable gland 120 and wall 150 of an electrical enclosure, forming a watertight seal between the cable gland 120 and wall 150 of the electrical enclosure.

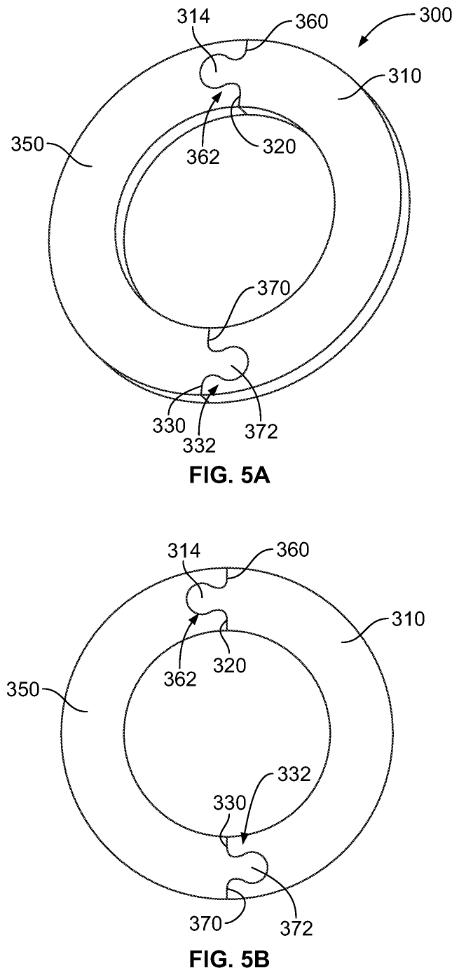

FIG. 5A is a top view of two-part washer 300, and FIG. 5B is a perspective view of two-part washer 300, in which two-part washer is shown with first part 310 and second part 350 in an interlocked state, providing an annular washer extending 360 degrees having any open interior through which an electrical cable may pass through.

In the interlocked state shown in FIGS. 5A and 5B, lobe 314 on first end 320 of first part 310 is positioned within, and interlocked with, recess 362 on second end 360 of second part 350. Similarly, lobe 372 on first end 370 of second part 350 is positioned within, and interlocked with, recess 332 on second end 330 of first part 310.

As can be seen in FIGS. 5A and 5B, lobe 314 fits within recess 362 like the lobe of a jigsaw puzzle piece, such that once in position the lobe 314 is interlocked with recess 362. Similarly, Lobe 372 fits within recess 332 like the lobe of a jigsaw puzzle piece, such that once in position the lobe 372 is interlocked with recess 332. Once the lobe 314 of the first part 310 is positioned within the recess 362 of second part 350, and lobe 372 of second part 350 is positioned within recess 332 of first part 320, an annular washer extending 360 degrees is formed having any open interior 380 through which an electrical cable may pass through.

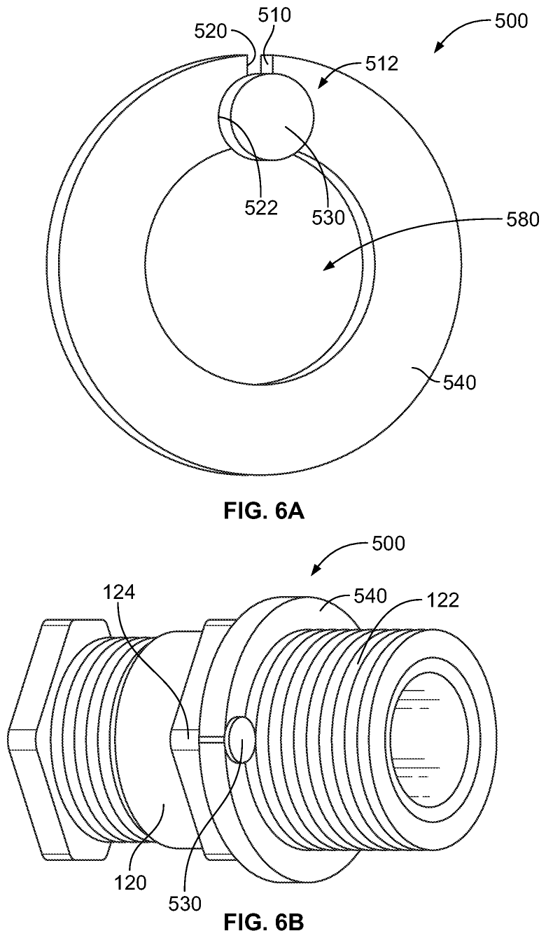

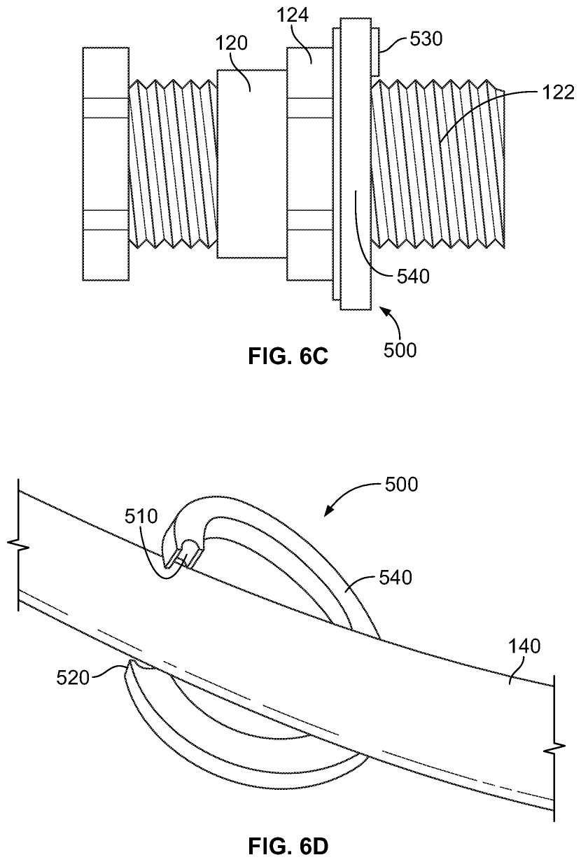

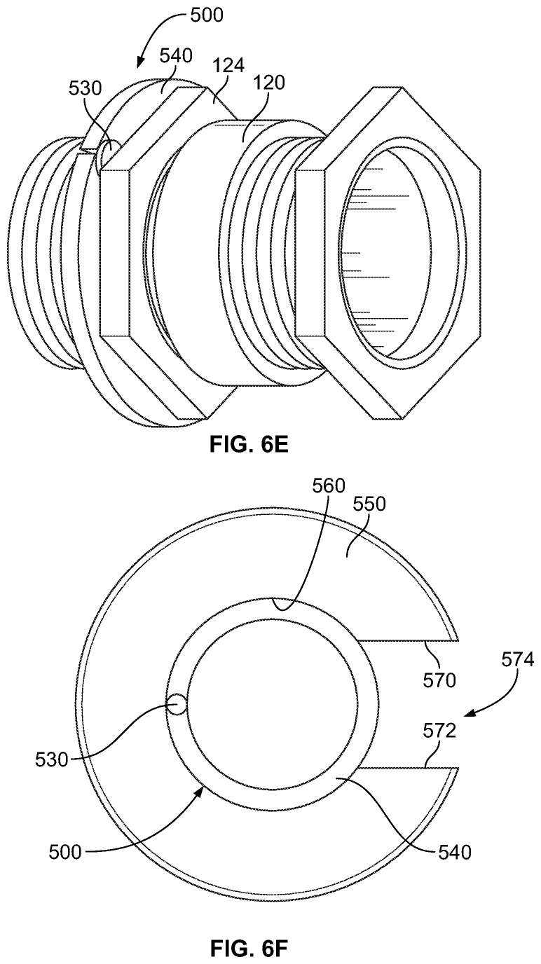

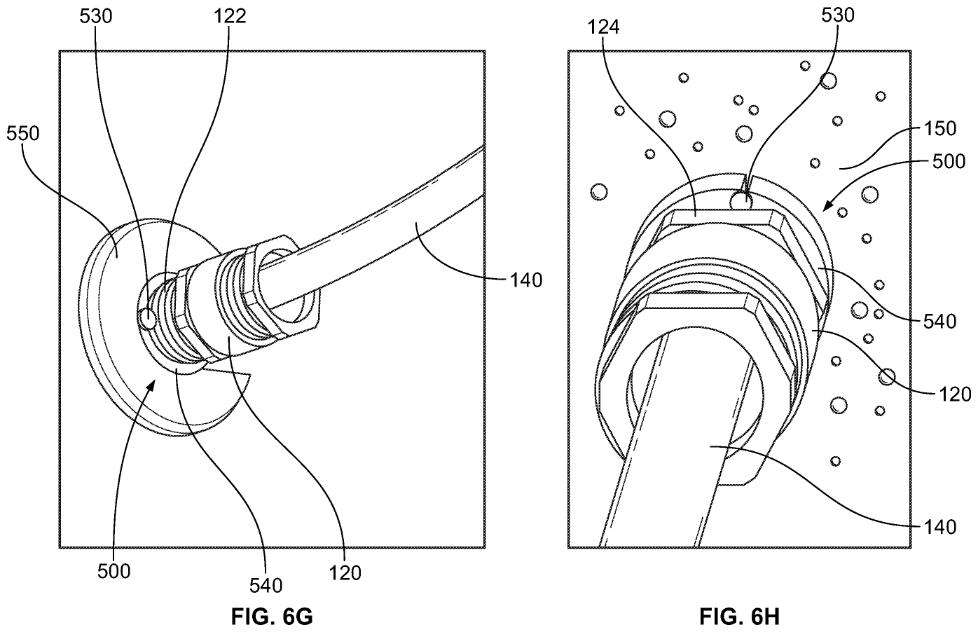

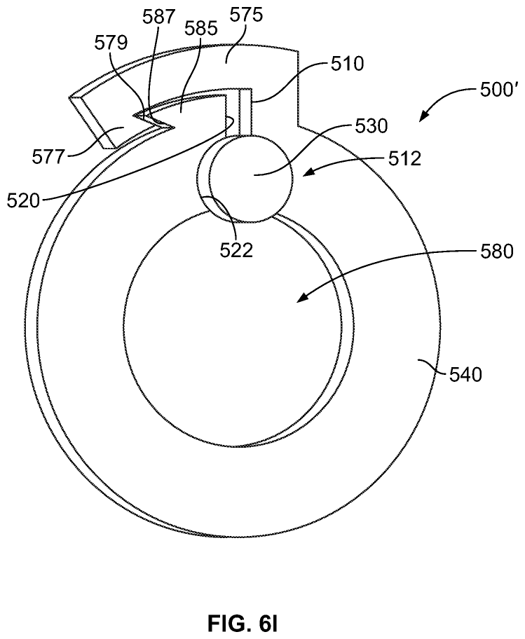

FIG. 6A is a top view of washer 500 having annular ring 540 and seal 530. Annular ring 540 is provided with a break, such that annular ring 540 has a first end 510 and a second end 520 that are adjacent to each other. First end 510 includes a rounded recess 512 in the form of a circular arc, and second end 520 includes a rounded recess 522 in the form of a circular arc. Circular seal 530 extends within rounded recesses 512 and 522.

FIG. 6B is a perspective view of washer 500 positioned over threaded section 122 of cable gland 120. FIG. 6C is a side view of washer 500 positioned over threaded section 122 of cable gland 120 positioned against nut section 124 of cable gland 120. As seen in FIG. 6C, seal 530 has a thickness that is greater than annular ring 540.

FIG. 6D is a perspective view of annular ring 540 of washer 500 being placed around electrical cable 140. In particular, first end 510 and second end 520 are spread apart to allow for electrical cable 140 to be inserted within annular ring 540 of washer 500. FIG. 6E is a perspective view of washer 500 positioned over cable gland 120, with cable gland 120 ready to be screwed into a cable entry in a wall of an electrical enclosure.

FIG. 6F is a perspective view of washer 500 positioned within tool 550. Tool 550 ensures that the seal 530 is compressed between ends 510 and 520 of annular ring 540 when the cable gland is screwed into the cable entry of a wall of an electrical enclosure. Tool 550 has a circular inner surface which conforms to the outer surface of annular ring 540. Tool 540 includes an opening 574 with ends 570 and 572. Opening 574 allows for the cable gland to pass through when the tool is removed after the cable gland has been screwed into the cable entry of a wall of an electrical enclosure.

FIG. 6G is a perspective view of washer 500 positioned over cable gland 120 and within tool 550, prior to cable gland 120 being threaded into a cable entry of a wall of an electrical enclosure. Tool 550 remains in position around the annular ring 540 and seal 530 as the cable gland is screwed into the cable entry of a wall of an electrical enclosure to insure that the seal 530 remains in a compressed state during the threading process. Once the cable gland 120 is fully screwed into the wall of the electrical enclosure, the cable gland 120 exerts a force on the annular ring 540 so that it remains with seal compressed between the ends of the annular ring. Once the cable gland is fully screwed in holding the washer 500 in place against the wall of an electrical enclosure, the tool 550 is removed by being lifted axially away from the washer 500, with the cable gland 120 passing through the opening 574 in tool 550.

FIG. 6H is a perspective view of cable gland 120 threaded into wall 150 of an electrical enclosure with washer 500 providing a watertight seal between cable gland 120 and wall 150.

FIG. 6I is a perspective view of washer 500′ which is a variant of washer 500 shown in FIGS. 6A-H. As with washer 550, washer 500′ includes annular ring 540 and seal 530. Annular ring 540 is provided with a break, such that annular ring 540 has a first end 510 and a second end 520 that are adjacent to each other. First end 510 includes a rounded recess 512 in the form of a circular arc, and second end 520 includes a rounded recess 522 in the form of a circular arc. Circular seal 530 extends within rounded recesses 512 and 522. Washer 500′ differs from washer 500 in that a locking extension 575 extends from first end 510 and a locking extension 585 extends from second end 520. Locking extension 575 extends over locking extension 585, and includes a downwardly extending tang 577 with a sloped surface 579 adapted to interlock with a notch formed by sloped surface 587 in locking extension 585. When tang 577 is positioned with the notch formed by sloped surface 587, the locking extensions 575 and 585 are in an interlocking position with the seal 530 squeezed between ends 510 and 520. As a result, of this locking arrangement, a tool, such as tool 550 is not required to maintain seal 530 tightly positioned within the ends 510 and 520 of annular ring 540 of washer 500′. It will be appreciated that the locking extensions could have other configurations and geometries than shown in FIG. 6I to provide for an interlocking arrangement.

The washers 200, 300, 400, 500, 500′, and 600 may be made of a polyamide wide family classified F1 for UV protection and having Yellow card, but all material compliant with IECEx and UL request may also be used without any restriction, which provides for a watertight seal between the cable gland and the wall of an electrical enclosure. This is particular useful in hazardous locations where the ingress of water or chemicals may cause a hazardous situation or cause electrical equipment within the electrical enclosure to malfunction.

It will be appreciated that certain configurations and geometries have been shown, but other configurations and geometries may also be used. For example, other ways of interlocking the ends of the two-part washer using different interlocking techniques may also be used.

In addition, the washers disclosed herein may vary in size to accommodate various sized electrical cables. For example, the washers described herein may be sized to accommodate electrical cables and cable glands used with M16 to M63 sized cable gland entries.

We claim:

1. A two-part washer for use with a cable gland comprising:
a first partial annular part having a first end and a second end; and
a second partial annular part having a first end and a second end;
wherein the first end of the first part is adapted to interlock with the second end of the second part;
wherein the second end of the first part is adapted to interlock with the first end of the second part; and
wherein when the ends of the first and second parts are interlocked, an annular washer extending 360 degrees with an open interior is formed.

2. The two-part washer of claim 1, wherein the first end of the first part has a lobe that fits in an axial direction into a recess on the second end of the second part to interlock the lobe within the recess; and
wherein the second end of the first part has a lobe that fits in an axial direction into a recess on the first end of the second part to interlock the lobe within the recess.

3. The two-part washer of claim 1, wherein the first end of the first part has a lobe that fits in an axial direction into a recess on the second end of the second part to interlock the lobe within the recess; and
wherein the first end of the second part has a lobe that fits in an axial direction into a recess on the second end of first second part to interlock the lobe within the recess.

4. The two-part washer of claim 3, where in the first part and the second part have an identical shape.

5. The two-part washer of claim 1, wherein the first end of the first part has a flange extending therefrom with an upward protrusion on the flange;
wherein the second end of the first part has a flange extending therefrom with an upward protrusion on the flange;
wherein the second end of the second part has a flange extending therefrom with an aperture in the flange;
wherein the first end of the second part has a flange extending therefrom with an aperture in the flange;
wherein the protrusion on the flange on the first end of the first part is adapted to fit in an axial direction into the aperture on the flange of the second end of the second part to interlock the first end of the first part with the second end of the second part; and
wherein the protrusion on the flange on the second end of the first part is adapted to fit in an axial direction into the aperture on the flange of the first end of the second part to interlock the first end of the first part with the second end of the second part.

6. The two-part washer of claim 1, wherein the two-part washer is positioned between an end of a cable gland and a wall of an electrical enclosure with an electrical cable extending through the open interior of the two-part washer when the ends of the first part are interlocked with the ends of the second part.

7. The two-part washer of claim 6, wherein the two-part washer forms a watertight seal between the end of the cable gland and the wall of the electrical enclosure.

8. A washer comprising:
an annular ring having an open interior, the annular ring having a break therein forming a first end of the ring and a second end of the ring; and
a seal positioned between the first end of the ring and the second end of the ring.

9. The washer of claim 8, wherein the first end of the ring has a rounded recess and the second end of the ring has a rounded recess; and wherein the seal has a circular cross-section and is positioned within the rounded recess on the first end of the ring and the rounded recess on the second end of the ring.

10. The washer of claim 9, wherein the washer is positioned between an end of a cable gland and a wall of an electrical enclosure with an electrical cable extending through the open interior of the washer.

11. The washer of claim 10, wherein the washer forms a watertight seal between the end of the cable gland and the wall of the electrical enclosure.

12. The washer of claim 8, wherein a first locking extension extends from the first end of the annular ring and a second locking extension extends from the second end of the annular ring; and
wherein the first locking extension extends over the second locking extension and the first locking extension includes a tang that extends into a notch in the second locking extension to compress the seal between the first end and the second end of the annular ring.

13. A method of providing a watertight seal between an end of a cable gland and a wall of an electrical enclosure, wherein an electrical cable extends through a cable entry in the wall into an interior of the electrical enclosure; comprising the steps of:
providing a two-part washer for use with a cable gland comprising:
a first partial annular part having a first end and a second end; and
a second partial annular part having a first end and a second end;
wherein the first end of the first part is adapted to interlock with the second end of the second part;
wherein the second end of the first part is adapted to interlock with the first end of the second part; and
wherein when the ends of the first and second parts are interlocked, an annular washer extending 360 degrees with an open interior is formed;
placing the first part around the electrical cable at a position between the cable gland and the wall of the enclosure;
placing the second part around an opposite side of the electrical cable than the first part;
interlocking the first end of the first part with the second end of the second part and interlocking the second end of the first part with the first end of the second part to form an annular washer extending 360 degrees with the electrical cable extending through the open interior; and
tightening the cable gland into the cable entry with the washer positioned between the cable gland and the wall of the electrical enclosure to form a watertight seal between the cable gland and the wall of the electrical enclosure.

14. The method of claim 13, wherein the first end of the first part has a lobe that fits in an axial direction into a recess on the second end of the second part to interlock the lobe within the recess; and
wherein the second end of the first part has a lobe that fits in an axial direction into a recess on the first end of the second part to interlock the lobe within the recess.

15. The method of claim 13, wherein the first end of the first part has a lobe that fits in an axial direction into a recess on the second end of the second part to interlock the lobe within the recess; and
wherein the first end of the second part has a lobe that fits in an axial direction into a recess on the second end of first second part to interlock the lobe within the recess.

16. The method of claim 15, wherein the first part and the second part have an identical shape.

17. The method of claim 13, wherein the first end of the first part has a flange extending therefrom with an upward protrusion on the flange;
wherein the second end of the first part has a flange extending therefrom with an upward protrusion on the flange;
wherein the second end of the second part has a flange extending therefrom with an aperture in the flange;
wherein the first end of the second part has a flange extending therefrom with an aperture in the flange;
wherein the protrusion on the flange on the first end of the first part is adapted to fit in an axial direction into the aperture on the flange of the second end of the second part to interlock the first end of the first part with the second end of the second part; and
wherein the protrusion on the flange on the second end of the first part is adapted to fit in an axial direction into the aperture on the flange of the first end of the second part to interlock the first end of the first part with the second end of the second part.

18. A method of providing a watertight seal between an end of a cable gland and a wall of an electrical enclosure, wherein an electrical cable extends through a cable entry in the wall into an interior of the electrical enclosure; comprising the steps of:
providing a washer comprising:
an annular ring having an open interior, the annular ring having a break therein forming a first end of the ring and a second end of the ring; and
a seal positioned between the first end of the ring and the second end of the ring;
locating a portion of the electrical cable between the cable gland and the wall of the enclosure;
moving the first and second ends of the annular ring apart and inserting the portion of the electrical cable into the open interior of the annular ring;
positioning the seal between the first end of the annular ring and the second end of the annular ring;
positioning the annular ring into a tool to compress the first end of the annular and the second end of the annular ring against the tool;
tightening the cable gland into the cable entry with the washer positioned between the cable gland and the wall of the electrical enclosure to form a watertight seal between the cable gland and the wall of the electrical enclosure; and
removing the tool.
